(19) United States
(12) Patent Application Publication
(10) Pub. No.: US 2026/0264979 A1
(43) Pub. Date: Sep. 10, 2026

(54) Garbage Bag with Incorporated Leak Absorption

(71) Applicant: Zecharia Zweig, Miami Beach, FL (US)

(72) Inventor: Zecharia Zweig, Miami Beach, FL (US)

(21) Appl. No.: 19/558,576

(22) Filed: Mar. 6, 2026

Related U.S. Application Data
(60) Provisional application No. 63/767,895, filed on Mar. 6, 2025.

(51) Int. Cl. B65F 1/14; B65F 1/00

(52) U.S. Cl. CPC B65F 1/14; B65F 1/002; B65F 2210/1023; B65F 2250/114

(57) ABSTRACT

The invention includes a garbage bag incorporating at least one absorbent material in the interior cavity of said bag, whereby said absorbent material is configured for absorbing liquid that is present in the interior of the bag thus being constructed and arranged for inhibiting and preventing leaks from exiting the bag.

### INDEX TO RELATED APPLICATIONS

This application is a non-provisional of and claims benefit to U.S> Provisional Patent Application Serial No. 63/767,895 filed Mar. 6, 2025, the disclosure of which is incorporated by reference in its entirety.

### BACKGROUND OF THE INVENTION

Currently, a vast majority of municipalities require garbage to be placed in bags to subsequently be handled by municipal sanitation. Most people know that garbage bags are prone to leak. These leaks create messes. Although there are a significant number of commercial products available, there still are many instances where these bags still leak. There is a need for a product that will address the leaking garbage bag. The present invention addresses this need.

### SUMMARY OF THE INVENTION

In one embodiment of the present invention, there is a padding in the garbage bag that will absorb liquid that is discarded into the bag. The interior of the bag includes an absorptive coating.

In one embodiment, the present invention is a garbage bag comprising:

a continuous unitary material that defines a front panel, a back panel, a left side, a right side, whereby said front panel and back panel separate along an upper edge to create an opening through which an interior cavity is accessed, said bag having an upper edge defined by said opening and a lower edge opposite said opening; and at least one absorptive material positioned within said interior cavity adjacent to said lower edge.

In one embodiment, the absorptive material is integral and unitary with said continuous unitary material.

In one embodiment, the absorptive material is attached to said continuous unitary material.

In one embodiment, the garbage bag includes a bag closure positioned within said interior cavity along said opening.

In one embodiment, the bag closure is configured as a garbage bag drawstring.

In one embodiment, the bag closure is configured as an adhesive coated member.

In one embodiment, the absorptive material is cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof.

In one embodiment, the absorptive material has a swelling capacity of 0.1-150 g/g.

In one embodiment, the absorptive material has a swelling capacity of 1.5 to 23.2 g/g.

In one embodiment, the present invention is a garbage bag consisting of: a continuous unitary material that defines a front panel, a back panel, a left side, a right side, whereby said front panel and back panel separate along an upper edge to create an opening through which an interior cavity is accessed, said bag having said upper edge defined by said opening and a lower edge opposite said opening; and at least one absorptive material selected from cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof, said absorbent material being positioned within said interior cavity adjacent to said lower edge.

In one embodiment, the present invention is a A garbage bag consisting of: a continuous unitary material that defines a front panel, a back panel, a left side, a right side, whereby said front panel and back panel separate along an upper edge to create an opening through which an interior cavity is accessed, said bag having said upper edge defined by said opening and a lower edge opposite said opening; and at least one absorptive material selected from cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof, said absorbent material being positioned within said interior cavity adjacent to said lower edge and having a swelling capacity of 1.5 to 23.2 g/g.

### BRIEF DESCRIPTION OF DRAWINGS

FIG. 1 is a front perspective view according to one embodiment of the present invention.

FIG. 2 is a front plan view according to one embodiment of the present invention.

FIG. 3 is a top view according to one embodiment of the present invention.

FIG. 4 is a side perspective view according to one embodiment of the present invention.

FIG. 5 is a detailed view of Detail A from FIG. 4.

FIG. 6 is a detailed view of Detail B from FIG. 4.

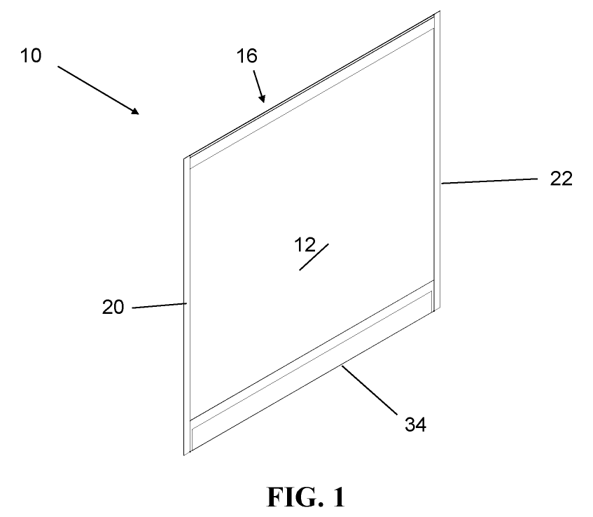

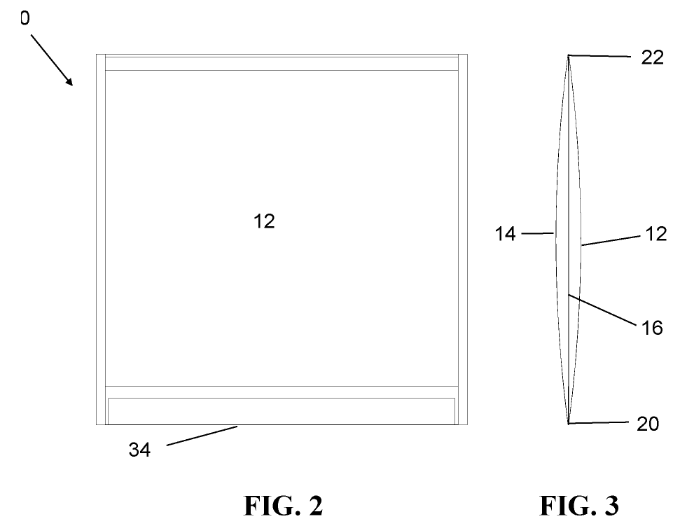

### DETAILED DESCRIPTION OF THE INVENTION

The bag of the present invention provides a unique configuration in which the interior of the produced bag includes an absorptive material.

As generally understood from the accompanying drawings, back system 10 has a front panel portion 12, a back panel portion 14, a left side 20, and a right side 22. Opening 16 positioned on the top side of bag system 10 accesses internal cavity 30. Proximal to opening 16 positioned within an internal cavity 30 is closure system 18. Closure system 18 includes those systems commonly known in the art such as drawstrings, adhesives and other such known mechanisms used to close plastic bags. Opposite opening 16 is bottom edge 34. As generally known and used in the art, the bag of the present mentioned is formed of a continuous piece of material. The portions of the bag as set forth herein are for clarity and do not indicate separately formed components. That is to say all of front panel portion 12, a back panel portion 14, a left side 20, and a right side 22 opening 16 and bottom edge 34 are formed of a single continuous material. Opening 16 is the interface on the upper portion of bag system 10 whereby front panel 12 and back panel 14 meet and are separable in order to access internal cavity 30.

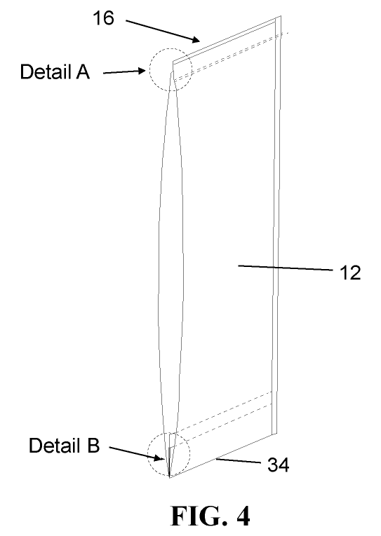

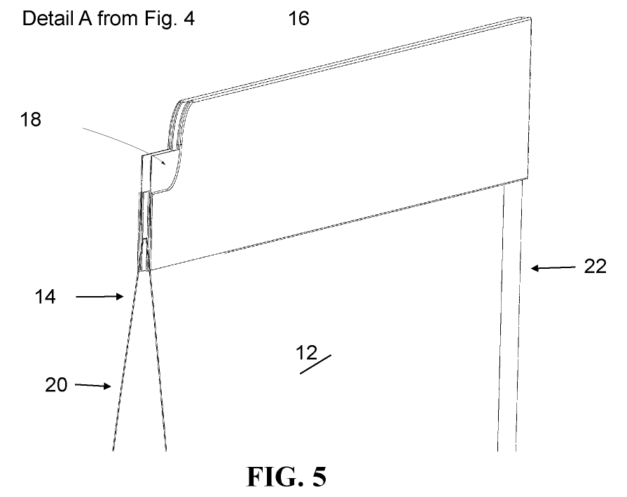

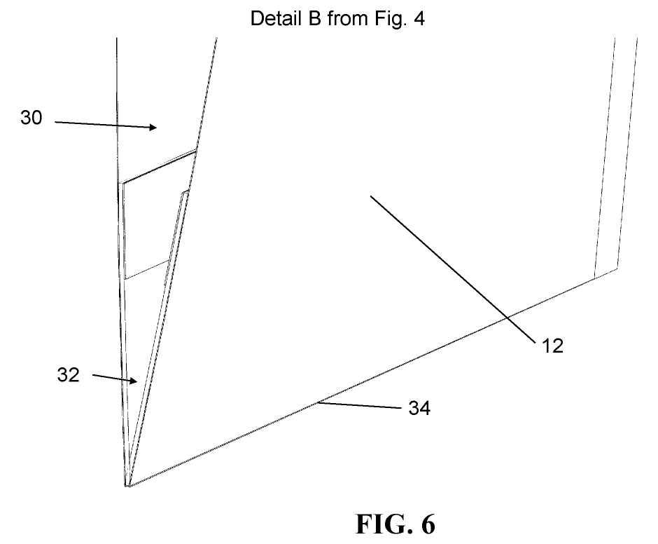

Positioned within internal cavity 30 along the bottom edge is absorbent material 32. Absorbent material 32 is either a material formed and placed as shown, a material sprayed into position as shown, or combinations thereof. FIG. 4 demonstrates placement of absorbent material 34 in a partial cross section and further detail demonstrating placement of absorbent material 34 is shown in expanded Detail B of FIG. 6.

FIG. 4 additionally demonstrates the position of the closure system 18 placed in cavity 30 along opening 16.

In one embodiment, the garbage bags of the present invention are produced by positioning absorbent material 32 in the bottom interior portion of the internal cavity 30 of garbage bag system 10 with suitable material being an absorbent material including cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof. Suitable material, as understood herein, is any material that has a swelling capacity sufficient to carry out the intent of the present invention. As is known, swelling capacity is typically expressed as grams of liquid absorbed per gram of material (g/g), as it represents the ratio of the weight of liquid absorbed to the initial weight of the material that absorbed it.

In one embodiment, the absorptive material is positioned after production of the bag and imparts an absorptive layer, according to the impetus of the present invention.

It is further contemplated, in one embodiment, that the absorptive material 30 be incorporated into the material used to construct the garbage according to one embodiment of the present invention.

As generally understood, garbage bag system 10 of the present prevention is provided whereby a user will access interior cavity 30 through opening 16. A user will place whatever waste products requiring disposal inside bag system 10. If there are any liquid components placed inside interior cavity, 30, gravity will impart them towards the bottom of the bag, and they will be absorbed by absorptive material 32.

The garbage bag system of the present prevention provides a much needed device as it is extremely common that persons who generate garbage containing liquid and solid components often encounter garbage bags that will leak the liquid components due to failure of the garbage bag material.

It is a critical component of the present prevention that the absorptive material be constructed and arranged as discussed that the material have characteristics and desired swelling capacity in order to absorb any liquid present with an interior cavity 30. In one embodiment absorbent material 32 will exhibit a swelling capacity of 0.1-150 g/g. In another embodiment, absorbent material 32 will exhibit a swelling capacity of 1.5 to 23.2 g/g. These ranges are not simple experimentation or substation but represent critical features to impart the desired characteristics in order to carry out the intended function of the present invention.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

1. A garbage bag comprising:
a continuous unitary material that defines a front panel, a back panel, a left side, a right side, whereby said front panel and back panel separate along an upper edge to create an opening through which an interior cavity is accessed, said bag having an upper edge defined by said opening and a lower edge opposite said opening; and
at least one absorptive material positioned within said interior cavity adjacent to said lower edge.

2. The garbage bag of claim 1, wherein said absorptive material is integral and unitary with said continuous unitary material.

3. The garbage bag of claim 1, wherein said absorptive material is attached to said continuous unitary material.

4. The garbage bag of claim 1 further including a bag closure positioned within said interior cavity along said opening.

5. The garbage bag of claim 4 wherein said bag closure is configured as a garbage bag drawstring.

6. The garbage bag of claim 4 wherein said bag closure is configured as an adhesive coated member.

7. The garbage bag of claim 1 wherein said absorptive material is cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof.

8. The garbage bag of claim 7 wherein said absorptive material has a swelling capacity of 0.1-150 g/g.

9. The garbage bag of claim 7 wherein said absorptive material has a swelling capacity of 1.5 to 23.2 g/g.

10. A garbage bag consisting of:
a continuous unitary material that defines a front panel, a back panel, a left side, a right side, whereby said front panel and back panel separate along an upper edge to create an opening through which an interior cavity is accessed, said bag having said upper edge defined by said opening and a lower edge opposite said opening; and
at least one absorptive material selected from cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof, said absorbent material being positioned within said interior cavity adjacent to said lower edge.

11. A garbage bag consisting of:
a continuous unitary material that defines a front panel, a back panel, a left side, a right side, whereby said front panel and back panel separate along an upper edge to create an opening through which an interior cavity is accessed, said bag having said upper edge defined by said opening and a lower edge opposite said opening; and at least one absorptive material selected from cellulose silica gel, sodium polyacrylate, Cross‐linked polyacrylates and polyacrylamides, cellulose‐ or starch‐acrylonitrile graft copolymers, cross‐linked maleic anhydride copolymers, or combinations thereof, said absorbent material being positioned within said interior cavity adjacent to said lower edge and having a swelling capacity of 1.5 to 23.2 g/g.
